(19) United States
(12) Patent Application Publication
(10) Pub. No.: US 2009/0172103 A1
(43) Pub. Date: Jul. 2, 2009

(54) EVENT BASED INSTANT MESSAGING NOTIFICATION

(75) Inventor: Apaar Tuli, Helsinki (FI)

Correspondence Address: PERMAN & GREEN, 425 POST ROAD, FAIRFIELD, CT, 06824, US

(73) Assignee: NOKIA CORPORATION, Espoo (FI)

(21) Appl. No.: 11/964,256

(22) Filed: Dec. 26, 2007

(51) Int. Cl. G06F 15/16

(52) U.S. Cl. 709/206

(57) ABSTRACT

A message is received in a device, the message is analyzed to determine a type of a content of the message, and a notification is provided to a user of the device, the notification being dependent on the type of message.

### BACKGROUND

1. Field

The disclosed embodiments generally relate to user interfaces and, more particularly, to instant message notifications in computer and mobile device.

2. Brief Description of Related Developments

Whenever a user is in engaged in a chat session, and the chat window is in the background, a flashing indication can be used to inform the user about messages that are received and are waiting to be read. Until the user opens the message, the user has no way to know whether the message from the other person is significant, insignificant, or just an acknowledging reply to the user's message. When an incoming message is not important, the user might not want to switch to the messaging window from their current window or task.

Current instant messaging solutions do not offer much information about the content of an incoming message or reply message. Messaging solutions offer the same type of indication to the user. These indications are merely trying to get the user's attention to the presence of an incoming and/or an unread IM from another person. This type of messaging notification can be disruptive and can break the user's concentration and workflow.

In a mobile device UI, where multitasking may be somewhat slower or more cumbersome than with a PC, such interaction may be too restrictive to expect the users to switch back and forth between different applications when a new message from another user arrives.

For example, in PC User Interfaces that support multi-tasking, an event inside an IM window in the background is generally indicated by flashing the background window's title or icon, or playing a sound, or both. To actually see the event that took place in the window, the user must bring that window to the foreground.

Sometimes the event is too minor to require immediate action, reaction or attention by the user. In the current implementations, there is no indication of whether or not the event requires or should require the user's attention. There is not differentiation in the notifications for messages of varying urgency or content.

In some instant messaging programs, there can be an audible notification, such as a “ping” functionality, that attempts to attract the user's attention. This message can generate a sound and title-bar flashing on the user's UI.

It would be advantageous to provide more customized notifications for different messaging and task types and scenarios. This could allow the user to decide whether or not to switch back to the IM window, without having to read the actual message first, to determine its content.

### SUMMARY

The disclosed embodiments are directed to a method, apparatus and computer program product for receiving a message in a device; analyzing the message to determine a type of a content of the message; and providing a notification to a user of the device, the notification being dependent on the type of message.

### BRIEF DESCRIPTION OF THE DRAWINGS

The foregoing aspects and other features of the embodiments are explained in the following description, taken in connection with the accompanying drawings, wherein:

FIG. 1 shows a block diagram of a system in which aspects of the disclosed embodiments may be applied;

FIG. 2 is flowchart illustrating an exemplary process flow of the disclosed embodiments;

FIG. 3 is an example of a message notification indicator of the disclosed embodiments;

FIG. 4 is an example of a message notification indicator of the disclosed embodiments;

FIG. 5 is an example of a message notification indicator of the disclosed embodiments;

FIGS. 6A and 6B are illustrations of examples of devices that can be used to practice aspects of the disclosed embodiments

FIG. 7 illustrates a block diagram of an exemplary system incorporating features that may be used to practice aspects of the disclosed embodiments; and

FIG. 8 is a block diagram illustrating the general architecture of an exemplary system in which the exemplary devices of FIGS. 6A and 6B may be used.

### DETAILED DESCRIPTION OF THE EMBODIMENT(s)

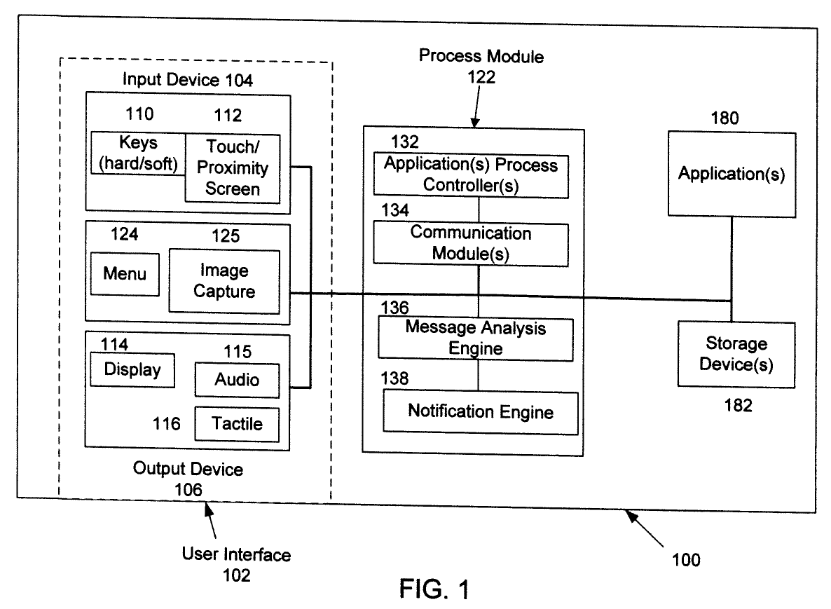

FIG. 1 illustrates one embodiment of a system 100 in which aspects of the disclosed embodiments can be applied. Although the disclosed embodiments will be described with reference to the embodiments shown in the drawings and described below, it should be understood that these could be embodied in many alternate forms. In addition, any suitable size, shape or type of elements or materials could be used.

The disclosed embodiments generally allow a user of a device or system, such as the system 100 shown in FIG. 1, to quickly and easily distinguish between different types of messages that are received. This allows the user the opportunity to decide which messages to immediately open and review or which messages to defer to a later time. For example, during a chat session where instant messaging is used, many different messages can be received. By providing different types of received message notifications to the user that distinguish messages based on relative importance, the user does not have to interrupt a current task or waste time opening messages that may not have to be reviewed or answered immediately. This allows the user to decide whether to open a message as soon as it is received or wait for a more appropriate or desired time. The notifications can be configured to vary in at least size, shape, form and/or intensity, depending upon a determination of a make-up of the content of the message. By varying an intensity of the notification, the user can be informed about the possible urgency of the incoming message.

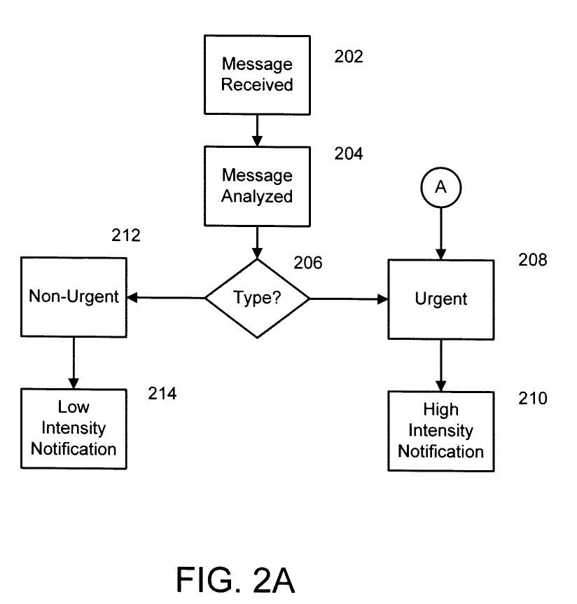

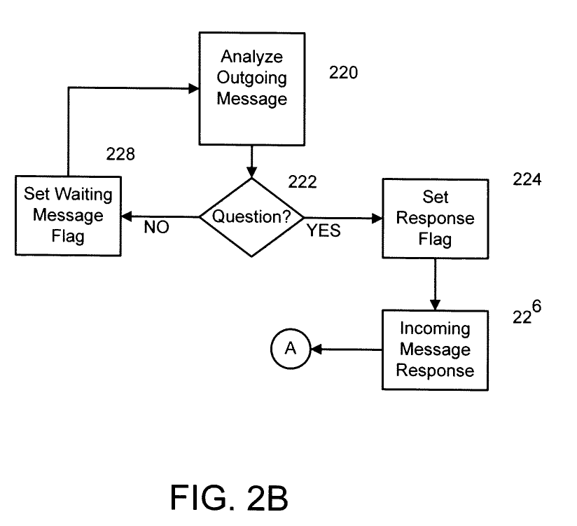

In one embodiment, referring to FIG. 2, an incoming message event 202 is detected by the device. The message can be any type of message suitable for or compatible with the underlying messaging application. For purposes of this description, the disclosed embodiments will be described with respect to an instant messaging application. In alternate embodiments, any suitable messaging application or system can be used, including for example, a text messaging (SMS) application. For example, when an incoming message is from a service provider, or appears to be marketing material or other junk style mail, then a low intensity notification is generated.

When the device receives the message 202, the message is analyzed 204 to determine at least the nature of the content of the message. Generally, the content of an incoming message will be analyzed to determine if the message includes information that is indicative of some urgency. Urgency is intended to imply that the incoming message requires more immediate attention and/or response from the message recipient. In alternate embodiments, the content of the message can be analyzed to determine any desired parameters. In a traditional messaging system, there is no distinction made between the content of urgent messages and the content of non-urgent messages. When a message is received, a notification is provided on the display of the device. The notifications do not vary in any factor from message to message. Thus, the user has no way to distinguish between an important or urgent message and a less-important or non-urgent message.

Once the message is analyzed 204, a determination 206 is made as to the type of message that is received. In one embodiment, the messages will be categorized as urgent 208 or non-urgent 212. An urgent message is one that is deemed important and/or requires some type of more immediate review and/or response from the recipient or user. A non-urgent message is one that is deemed to have low importance and/or does not require any immediate review and/or response from the user.

Once the type of the received message is characterized, a notification type is assigned to the message and provided to the user. In one embodiment, two types of notifications will be provided to the user, a high intensity notification 210 and a weak or low intensity notification 214. A high intensity notification 210 corresponds to a message categorized as urgent 208. A low intensity notification 214 corresponds to a message categorized as a non-urgent or standard message 212. The characteristics of a weak or low intensity notification 214 can be less than those of a high intensity notification 212. This way, an urgent message, or one desiring review and/or response from the user will be associated with a notification 212 of high intensity, while a non-urgent message, or one not desiring more immediate review and/or response will be associated with a standard or less intense notification 214. The disclosed embodiments allow a user to determine from the notification, whether or not the message is urgent or non-urgent, and decide, based solely on the received message notification, whether or not to bring the message to the foreground for analysis and action, or to hold or defer the message for later review.

In one embodiment, the analysis 204 of the message content can include analyzing the relevant punctuation, grammatical structure, or word usage of the message. In alternate embodiments, any suitable algorithm can be applied to a message to determine whether or not the content of the message is indicative of requiring a more immediate review and/or response. Analyzing the relevant punctuation or grammatical structure can include for example, identifying the types of punctuation in the message. Examples of punctuation that can be searched for can include, for example, exclamation points, question marks, quotation marks, period use, asterisk or stars. The identification of one or more punctuation marks in a message, either alone or in combination, can be used to assign a relative importance or urgency of a message. This can be used to identify messages that require a more direct and informative notification to the user. For example, a message that has one or more exclamation marks “!”, might indicate an urgent type of message. Similarly, if the message is a question, such as “Hi, there! What is up?”, the use and detection of at least the question mark in the sentence can be a prompt to classify the message as an urgent message or one that should be responded to rather than deferred. In one embodiment, it could be the combination of the question mark and the exclamation point in the message that is used to categorize the message as an urgent message. Some examples of how messages might be analyzed and categorized follow below.

In one embodiment, when a user is engaged in a chat with one user, all messages from other users, by default, are categorized as non-urgent and the notification for a message received by some other user would be a low intensity notification.

If it is the first message from the other person, then the message is categorized as urgent and the notification is a high intensity notification.

In one embodiment, if a message sent from the user is a question (analyzed through the grammatical structure or use of relevant punctuation), then when the other person replies to that message, the reply message received by the user is categorized as urgent, and the notification is a high intensity notification. In this example, an analysis of the outgoing message is undertaken to determine if the message is a question, or one requiring a response. The system determines when a response to the sent question message is received, and automatically designates the responsive received message as an urgent message requiring a high intensity notification. For example, referring to FIG. 2B, the user sends the message “Are you coming to have lunch at 12.00?” Prior to or as the system is sending the message, the message is analyzed 220 to determine if it is an urgent message. The analysis can be similar to the analysis performed on an incoming message, as described with respect to FIG. 2A. The system 100 determines 222 whether the outgoing message is an urgent message, such as a question, for example. If the message is determined to be an urgent message, a flag or other marker is set 224 in the system. The flag indicates that an urgent message has been sent to another user, and that the response from the other user is to be handled in a specific manner. When a response message from the other user is received 226, the system 100 automatically categorizes the incoming response message as an urgent message, and a high-intensity notification is assigned as described in FIG. 2A.

As another example, if the preceding message from the user does not indicate a question, and the other person replies to that message with only a few words, such as one or two words, then the notification is a low or weak intensity notification. For example, the user sends a message “The weather is so lousy today.” The outgoing message is analyzed by the system 100. The system 100 marks 228 that an outgoing message has been sent and waits for the response to this message. When the response message is received, it can be processed as shown in FIG. 2A. In this example, the response is simply “Yes”. The analysis of the response will include that the message is in response to a message sent by the user. In this example, the number of words in the response message can also be used to categorize the message. Since the response message only contains a few words, the response message is categorized as non-urgent. In alternate embodiments, any suitable criteria can be used to categorize a message that is received in response to a message sent by the user.

In one embodiment, if the user sets a status flag in the device as “busy”, “on the phone”, “do not disturb”, or some other similar device or user status setting, then all notifications provided to the user are low intensity notifications, until the user changes that status. Each message being received by the device is automatically processed as a low intensity message when the status flag is set to a busy setting. These flags can be set in any known fashion, such as for example, using the profile function of the device.

The types of letters used or the format of the letters used can be analyzed to determine if the message should be categorized as a non-urgent, low intensity or urgent, high intensity message. For example, if the message received in the device from the other person is written in all capital letters, such as “HEY, CHECK THIS OUT!” then the message is categorized as an urgent message and a high intensity notification is set. Sending a message in all capital letters can be considered akin to shouting in the online world. In this example too, the use of the exclamation point may also be an indicator of an urgent message, either by itself or in combination with the use of all capital letters. In alternate embodiments, any suitable combination or letter format and/or punctuation can be used. For example, if only the first letter of each word is capitalized, the message can be categorized as urgent. In another embodiment, if a number or certain numbers are included either before, as part of, or at the end of a message, the analysis of the message will result in the message being categorized as urgent.

As another example, the number of messages received from another person during a certain time period can be used as the prompt to trigger a high intensity notification for a message. For example, if the other person has written a message that has generated a weak intensity notification for the user, the user might choose not to bring the messaging window to the foreground. However, if the other person keeps writing more messages that result in low intensity notifications, with each such message remaining in the background, then after a fixed number of messages in the background, (e.g. three), the next message can be categorized as a high intensity message. This lets the user know that the other person is probably looking for a reply. Alternatively, in one embodiment, if the system determines that the user has received more than a certain number of non-urgent messages that have not yet been reviewed, then the system can change the notification for each previously received message from low intensity to high intensity, with each changed notification being newly provided to the user. In one embodiment, a changed and re-delivered notification can be marked as a changed notification so that the user can easily distinguish a changed and re-presented notification for an already received message.

In one embodiment, the user can pre-define how incoming messages will be analyzed, and set the type of algorithm or analysis criteria to be applied to each incoming message. For example, using a settings option menu the user can define that all questions will be categorized as urgent, or that all messages including an exclamation point and/or all capital letters will be categorized as urgent. The settings menu could also include a wild card field, where the user is able to insert one or more free criteria, such as a name, an alphanumeric, a term or code, that when determined to be part of or associated with a message, automatically results in the message being categorized as urgent or non-urgent. In one embodiment, the settings menu can include options for all applicable search and analysis criteria. The user might be able to select individual options or groups of analysis options. In alternate embodiments, pre-packaged algorithms can be presented to the user for selection. The settings for each of the examples noted above can be set using the settings menu. The disclosed embodiments allow the user to pre-define how incoming messages are to be analyzed and categorized according to the pre-defined criteria.

In one embodiment, the user can also pre-define to automatically designate messages received from certain persons as urgent messages, requiring a high intensity notification. For example, a user can create a list of other persons from which the user wishes to receive messages on a priority basis. When a message is received, the analysis engine compares the identify of the sender of the message to the user's list. If a match is noted, the message is marked or categorized as urgent. The notification engine will then provide a high intensity notification to the user.

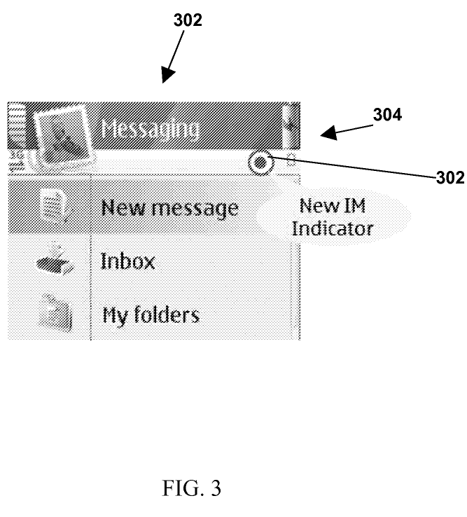

Referring to FIG. 3, in one embodiment the notification 306 can be presented to the user via the user interface 302 of the device. As shown in FIG. 3, the notification 306 is shown in conjunction with the user interface 302 for the messaging application 304. In this embodiment, the user has opened the messaging application 304 and the notification icon 306 is displayed therewith. However, in alternate embodiments the notification icon 306 can be displayed whether or not the user has the messaging application 304 running, or running in the foreground of the user interface.

Generally, the notification 306 should be provided in a manner that is easily perceptible by the user of the device and should allow the user to be able to determine whether or not to switch to the messaging application 304 from a current task. For example, a user might be working in some other task or application on the device. When a message arrives, the notification 306 should be perceptible whether or not the user has the messaging application 304 open or in the foreground. Although a visual notification is discussed herein, it should be understood that in alternate embodiments, the notification 306 can be other than including a visually perceptible notification. For example, the notification 306 can also be an aural notification, such as a sound, or one that can be perceived by feel, such as a vibration. The notification 306 can also comprise any combination of sight, sound and feel. In one embodiment, a change in the backlighting or intensity of the backlighting can be used to inform the user about an incoming or received message.

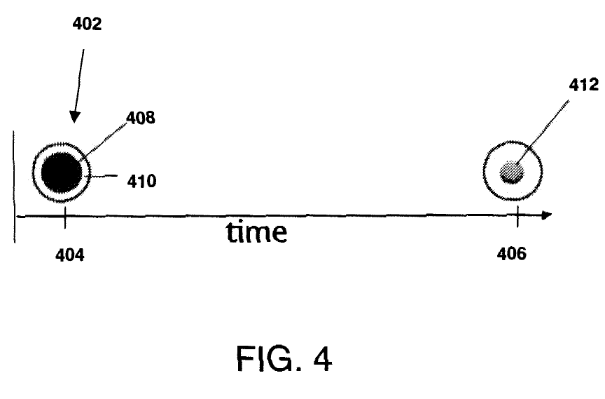

In the embodiments described herein, different types of notifications are use. FIG. 4 illustrates one example of a low intensity or weak notification. The example in FIG. 4 comprises a looping animation, where the icon 402 has a distinct contrast relative to the background of the user interface at a first point in time 404, but then fades or diminishes to a less distinct contrast and size relative to the background by a second point in time 404. In this example, the icon 402 comprises an indicator 408 inside of a circular border 410. In this embodiment, the indicator 408 fades to a diminished contrast as shown by the indicator 412, while the border 410 remains relatively constant in contrast. This allows the indication of a received message to easily be perceived by the user, via the indication border 410, while the type, urgency or non-urgency, is presented via a second aspect of the icon 402, the notification indicator 408. In alternate embodiments, any suitable indicator can be used, such as for example an alphanumeric indicator or other shape and size. In this example, the type aspect 408 of the icon 402 fades over a time period to indicate a non-urgent type of message. The time period or cycle can be any suitable period, and should be such to allow the user to easily and quickly perceive the type of message with limited interruption. Although a looping notification is illustrated, in alternate embodiments any suitable notification can be provided that alerts the user to a notification and allows the user to differentiate between a non-urgent and urgent message, as described herein.

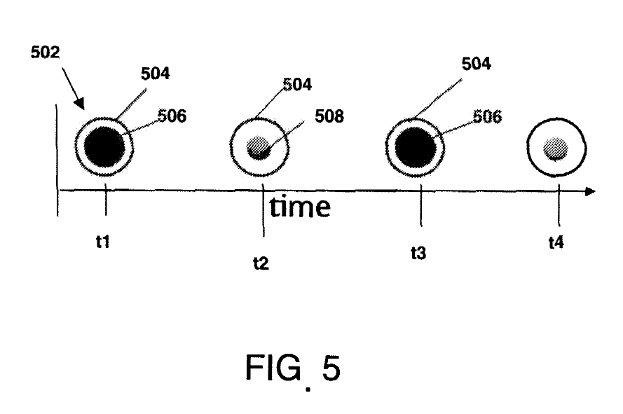

FIG. 5 illustrates one example of a high intensity notification icon 502 according to the disclosed embodiments. The is also a looping animation icon 502 where at a first point in time t1, when the icon 502 is first presented, the size and contrast of the icon 502 is distinct relative to a background of the user interface on which it is being presented. The icon 502 shown in FIG. 5 generally comprises a circular shape having an outer border 504 and an inner filled section 506. In alternate embodiments, any suitable icon can be used of any suitable shape, size or image. At a second point in time t2, the size and contrast of the icon 502 is diminished relative to the first point in time t1. In this example, the outer border 504 remains generally constant from a visual presentation, while the inner section 508 fades relative to the first point in time t1. The time period between the first point in time t1 and the second point in time t2 is generally less than the time period shown in FIG. 4. Since the icon 502 in FIG. 5 is a looping animation, at the third point in time t3, the size, contrast and intensity of the inner section 506 of the icon 502 once again has increased relative to the second point in time t2. At the fourth point in time t4, the size and intensity of the icon 502 once again appears diminished relative to the previous point in time. In this fashion the appearance of the notification icon 502 appears to flash or signal to the user. In one embodiment, the looping animation of the high intensity notification icon 502 of FIG. 5 can be twice the speed of the low intensity icon 402 of FIG. 4. In alternate embodiments, any suitable notification icon can be used to present and differentiate between a high intensity notification and a low intensity notification. For example, in one embodiment, the icon 502 can appear as a constant image. Alternatively, only the size of the icon 502 might vary to distinguish between a low intensity and a high intensity notification. In one embodiment, a graphical image might be used as the notification, where one image is used for a low intensity notification 402 and another image is used for the high intensity notification 502. Any factor of the notification can be varied to distinguish a low intensity notification 402 from a high intensity notification 502, including color, size, shape, image or type, for example.

Referring to FIG. 1, the system of the disclosed embodiments can include an input device 104, output device 106, process module 122, applications module 180, and storage/memory 182. The components described herein are merely exemplary and are not intended to encompass all components that can be included in the system 100. The input device 104 is configured to allow a user to input data and commands to the system or device 100. The output device 106 is configured to allow information and data to be presented to the user via a user interface of the device 100. The process module 122 is generally configured to execute the processes and methods of the disclosed embodiments. The application process controller 132 can be configured to interface with the applications module 180 and execute applications processes with respects to the other modules of the system 100. The communication module 134 is configured to allow the device to send communications and messages, such as text messages, chat messages and email. The communications module 134 is also configured to receive communications from other devices and systems. The message analysis engine 136 is used to receive, process and analyze messages, both incoming and outgoing, in accordance with the disclosed embodiments. The notification engine is configured to categorize messages in conjunction with the message analysis engine and generate corresponding notifications to the user in accordance with the embodiments disclosed herein.

The applications module 180 can include any one of a variety of applications that may be installed, configured or accessible by the device 100. In one embodiment, the system 100 comprises a mobile communication device. The mobile communication device can be Internet enabled. The input device 104 can also include a camera or such other image capturing system. The applications of the device may include, but are not limited to, data acquisition (e.g. image, video and sound) and multimedia players (e.g. video and music players). In alternate embodiments, the system 100 can include other suitable devices and applications for capturing and storing images and transferring the images to an online service.

While the input device 104 and output device 106 are shown as separate devices, in one embodiment, the input device 104 and output device 106 can be combined and be part of, and form, the user interface 102. The user interface 102 can be used to display information pertaining to multi-media content as will be described below.

In one embodiment, the user interface of the disclosed embodiments can be implemented on or in a device that includes a touch screen display or a proximity screen device. In alternate embodiments, the aspects of the user interface disclosed herein could be embodied on any suitable device that will display information and allow the selection and activation of applications or system content. The terms “select” and “touch” are generally described herein with respect to a touch screen-display. However, in alternate embodiments, the terms are intended to encompass the required user action with respect to other input devices. For example, with respect to a proximity screen device, it is not necessary for the user to make direct contact in order to select an object or other information. Thus, the above noted terms are intended to encompass that a user only needs to be within the proximity of the device to carry out the desired function.

Similarly, the scope of the intended devices is not limited to single touch or contact devices. Multi-touch devices, where contact by one or more fingers or other pointing devices can navigate on and about the screen are also intended to be encompassed by the disclosed embodiments. Non-touch devices are also intended to be encompassed by the disclosed embodiments. Non-touch devices include, but are not limited to, devices without touch or proximity screens, where navigation on the display and menus of the various applications is performed through, for example, keys 110 of the system or through voice commands via voice recognition features of the system.

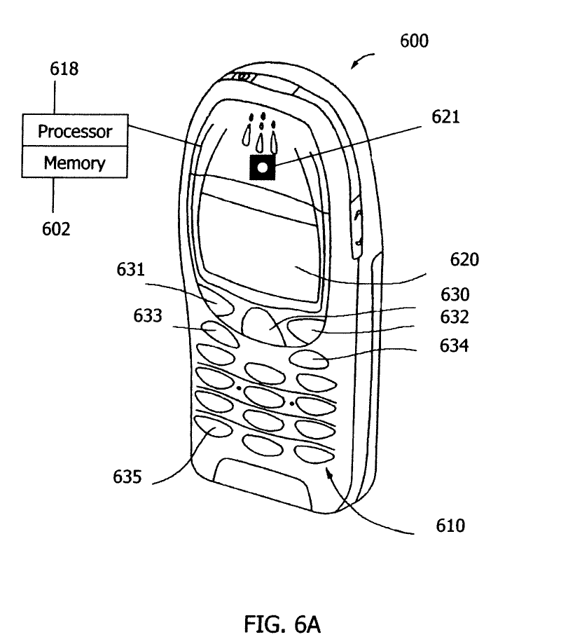

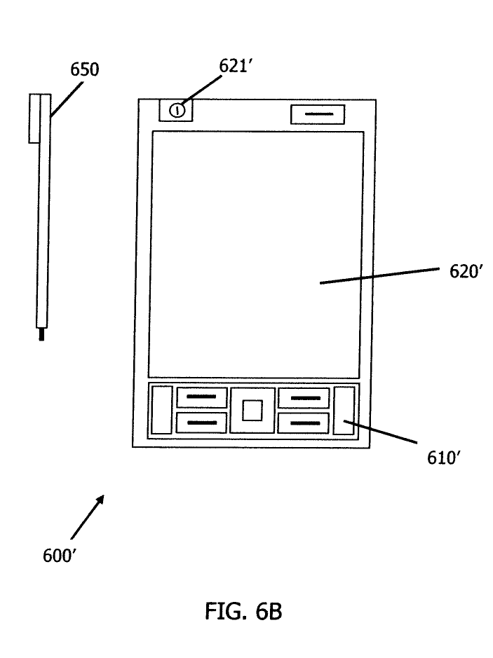

Some examples of devices on which aspects of the disclosed embodiments can be practiced are illustrated with respect to FIGS. 6A and 6B. The devices are merely exemplary and are not intended to encompass all possible devices or all aspects of devices on which the disclosed embodiments can be practiced. As shown in FIG. 6A, in one embodiment, the terminal or mobile communications device 600 may have a keypad 610 as an input device and a display 620 for an output device. The keypad 610 may include any suitable user input devices such as, for example, a multi-function/scroll key 630, soft keys 631, 632, a call key 633, an end call key 634 and alphanumeric keys 635. In one embodiment, the device 600 includes an image capture device such as a camera 621 as a further input device. The display 620 may be any suitable display, such as for example, a touch screen display or graphical user interface. The display may be integral to the device 600 or the display may be a peripheral display connected or coupled to the device 600. A pointing device, such as for example, a stylus, pen or simply the user's finger may be used in conjunction with the display 620 for menu selection and other input and commands. In alternate embodiments any suitable pointing or touch device may be used. In other alternate embodiments, the display may be a conventional display. The device 600 may also include other suitable features such as, for example a loud speaker, tactile feedback devices or connectivity port. The mobile communications device may have a processor 618 connected to the display for processing user inputs and displaying information on the display 620. A memory 602 may be connected to the processor 618 for storing any suitable information, data, settings and/or applications associated with the mobile communications device 600.

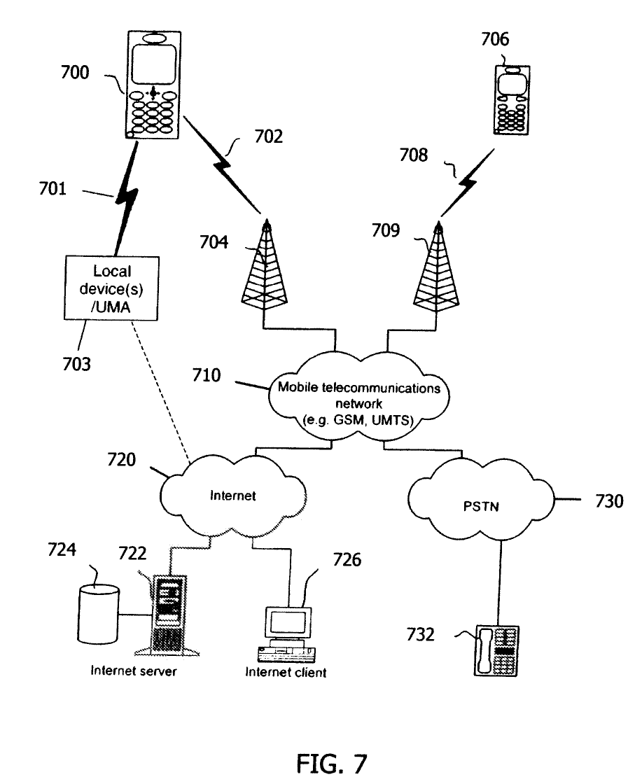

In the embodiment where the device 600 comprises a mobile communications device, the device can be adapted for communication in a telecommunication system, such as that shown in FIG. 7. In such a system, various telecommunications services such as cellular voice calls, worldwide web/wireless application protocol (www/wap) browsing, cellular video calls, data calls, facsimile transmissions, data transmissions, music transmissions, still image transmission, video transmissions, electronic message transmissions and electronic commerce may be performed between the mobile terminal 700 and other devices, such as another mobile terminal 706, a line telephone 732, a personal computer 751 and/or an internet server 122. In one embodiment the system is configured to enable any one or combination of chat messaging, instant messaging, text messaging and/or electronic mail. It is to be noted that for different embodiments of the mobile terminal 700 and in different situations, some of the telecommunications services indicated above may or may not be available. The aspects of the disclosed embodiments are not limited to any particular set of services in this respect.

The mobile terminals 700, 706 may be connected to a mobile telecommunications network 77 through radio frequency (RF) links 702, 708 via base stations 704, 709. The mobile telecommunications network 710 may be in compliance with any commercially available mobile telecommunications standard such as for example global system for mobile communications (GSM), universal mobile telecommunication system (UMTS), digital advanced mobile phone service (D-AMPS), code division multiple access 2000 (CDMA2000), wideband code division multiple access (WCDMA), wireless local area network (WLAN), freedom of mobile multimedia access (FOMA) and time division-synchronous code division multiple access (TD-SCDMA).

The mobile telecommunications network 710 may be operatively connected to a wide area network 720, which may be the Internet or a part thereof. An Internet server 722 has data storage 724 and is connected to the wide area network 720, as is an Internet client computer 726. The server 722 may host a worldwide web/wireless application protocol server capable of serving worldwide web/wireless application protocol content to the mobile terminal 700.

A public switched telephone network (PSTN) 730 may be connected to the mobile telecommunications network 710 in a familiar manner. Various telephone terminals, including the stationary telephone 732, may be connected to the public switched telephone network 730.

The mobile terminal 700 is also capable of communicating locally via a local link 701 or 751 to one or more local devices 703 or 750. The local links 701 or 751 may be any suitable type of link with a limited range, such as for example Bluetooth, a Universal Serial Bus (USB) link, a wireless Universal Serial Bus (WUSB) link, an IEEE 802.11 wireless local area network (WLAN) link, an RS-232 serial link, etc. The local devices 703 can, for example, be various sensors that can communicate measurement values to the mobile terminal 700 over the local link 701. The above examples are not intended to be limiting, and any suitable type of link may be utilized. The local devices 703 may be antennas and supporting equipment forming a wireless local area network implementing Worldwide Interoperability for Microwave Access (WiMAX, IEEE 802.16), WiFi (IEEE 802.11x) or other communication protocols. The wireless local area network may be connected to the Internet. The mobile terminal 700 may thus have multi-radio capability for connecting wirelessly using mobile communications network 710, wireless local area network or both. Communication with the mobile telecommunications network 710 may also be implemented using WiFi, Worldwide Interoperability for Microwave Access, or any other suitable protocols, and such communication may utilize unlicensed portions of the radio spectrum (e.g. unlicensed mobile access (UMA)). In one embodiment, the navigation module 122 of FIG. 1 can include a communications module that is configured to interact with the system described with respect to FIG. 7.

Although the above embodiments are described as being implemented on and with a mobile communication device, it will be understood that the disclosed embodiments can be practiced on any suitable device incorporating a display, processor, memory and supporting software or hardware. In one embodiment, the system 100 of FIG. 1 may be for example, a personal digital assistant (PDA) style device 600′ illustrated in FIG. 6B. The personal digital assistant 600′ may have a keypad 610′, a touch screen display 620′, camera 621′ and a pointing device 650 for use on the touch screen display 620′. In still other alternate embodiments, the device may be a personal computer, a tablet computer, touch pad device, Internet tablet, a laptop or desktop computer, a mobile terminal, a cellular/mobile phone, a multimedia device, a personal communicator, a television or television set top box, a digital video/versatile disk (DVD) or High Definition player or any other suitable device capable of containing for example a display 114 shown in FIG. 1, and supported electronics such as the processor 618 and memory 602 of FIG. 6A.

The user interface 102 of FIG. 1 can also include menu systems 124 coupled to the processing module 122 for allowing user input and commands. The processing module 122 provides for the control of certain processes of the system 100 including, but not limited to the controls for receiving messages, accepting messages, opening messages and responding to messages. The menu system 124 can provide for the selection of different tools and application options related to the applications or programs running on the system 100 in accordance with the disclosed embodiments. In one embodiment, the menu system 124 may provide for establishing the analysis and algorithm settings of the message analysis engine 136 and notification engine 138 of FIG. 1. In the embodiments disclosed herein, the process module 122 receives certain inputs, such as for example, signals, transmissions, instructions or commands related to the functions of the system 100, such as messages and notifications. Depending on the inputs, the process module 122 interprets the commands and directs the process control 132 to execute the commands accordingly in conjunction with the other modules, such as message analysis engine 136 and notification engine 138.

Referring again to FIG. 1, the display 114 of the system 100 can comprise any suitable display, such as noted earlier, a touch screen display, proximity screen device or graphical user interface. In one embodiment, the display 114 can be integral to the system 100. In alternate embodiments the display may be a peripheral display connected or coupled to the system 100. A pointing device, such as for example, a stylus, pen or simply the user's finger may be used with the display 114. In alternate embodiments any suitable pointing device may be used. In other alternate embodiments, the display may be any suitable display, such as for example a flat display 114 that is typically made of an liquid crystal display (LCD) with optional back lighting, such as a thin film transistor (TFT) matrix capable of displaying color images. A touch screen may be used instead of a conventional liquid crystal display.

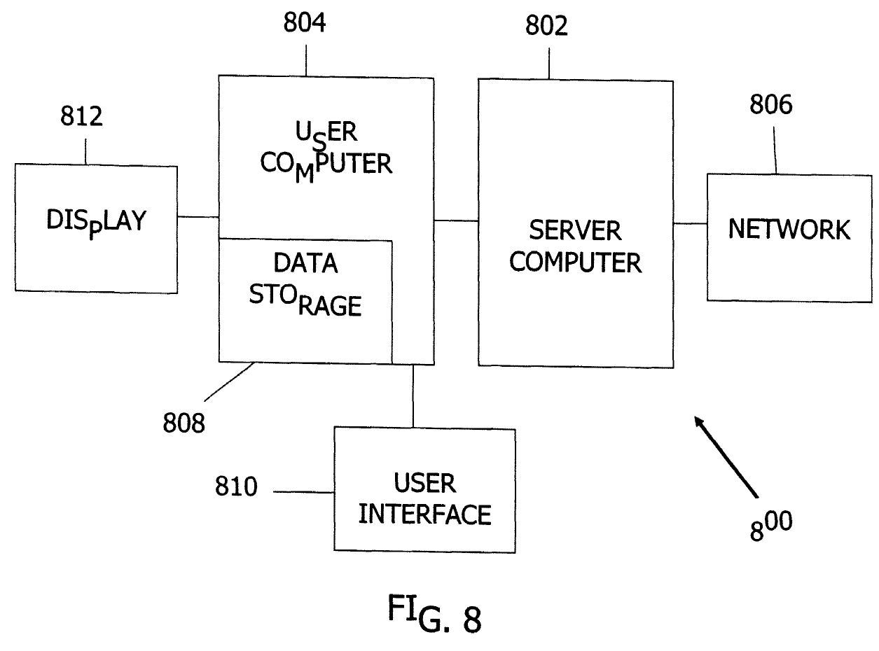

The disclosed embodiments may also include software and computer programs incorporating the process steps and instructions described above that are executed in different computers. FIG. 8 is a block diagram of one embodiment of a typical apparatus 800 incorporating features that may be used to practice aspects of the invention. The apparatus 800 can include computer readable program code means for carrying out and executing the process steps described herein. In one embodiment the computer readable program code is stored in a memory of the device. In alternate embodiments the computer readable program code can be stored in memory or memory medium that is external to the apparatus 800. The memory can be direct coupled or wireless coupled to the apparatus 800. As shown, a computer system 802 may be linked to another computer system 804, such that the computers 802 and 804 are capable of sending information to each other and receiving information from each other. In one embodiment, computer system 802 could include a server computer adapted to communicate with a network 806. Computer systems 802 and 804 can be linked together in any conventional manner including, for example, a modem, wireless, hard wire connection, or fiber optic link. Generally, information can be made available to both computer systems 802 and 804 using a communication protocol typically sent over a communication channel or through a dial-up connection on an integrated services digital network (ISDN) line or other such communication channel or link. In one embodiment, the communication channel comprises a suitable broad-band communication channel. Computers 802 and 804 are generally adapted to utilize program storage devices embodying machine-readable program source code, which is adapted to cause the computers 802 and 804 to perform the method steps and processes disclosed herein. The program storage devices incorporating aspects of the invention may be devised, made and used as a component of a machine utilizing optics, magnetic properties and/or electronics to perform the procedures and methods disclosed herein. In alternate embodiments, the program storage devices may include magnetic media, such as a diskette, disk, memory stick or computer hard drive, which is readable and executable by a computer. In other alternate embodiments, the program storage devices could include optical disks, read-only-memory (“ROM”) floppy disks and semiconductor materials and chips.

Computer systems 802 and 804 may also include a microprocessor for executing stored programs. Computer 802 may include a data storage device 808 on its program storage device for the storage of information and data. The computer program or software incorporating the processes and method steps incorporating aspects of the invention may be stored in one or more computers 802 and 804 on an otherwise conventional program storage device. In one embodiment, computers 802 and 804 may include a user interface 810, and/or a display interface 812 from which aspects of the invention can be accessed. The user interface 810 and the display interface 812, which in one embodiment can comprise a single interface, can be adapted to allow the input of queries and commands to the system, as well as present the results of the commands and queries.

The embodiments described herein provide a user with a quick and easy way to identify messages that me require an more immediate review and response than can be done with a traditional messaging system. Messages that are received are analyzed to identify the type of message. From the type of message a corresponding notification can be issued, which identifies the type of message to the user. From the notification the user can determine whether to view the message immediately, or defer the message for a later time.

It is noted that the embodiments described herein can be used individually or in any combination thereof. It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. A method comprising:
receiving a message in a device;
analyzing the message to determine a type of a content of the message; and
providing a notification to a user of the device, the notification being dependent on the type of message.

2. The method of claim 1 wherein the type of content of the message is urgent or non-urgent.

3. The method of claim 2 wherein the notification to the user is a high intensity notification when the type of message is urgent and a low intensity message when the type of message is non-urgent.

4. The method of claim 1 wherein analyzing the message comprises analyzing a grammatical structure of the message.

5. The method of claim 4 wherein analyzing the grammatical structure further comprises identifying one or more punctuation marks in the message, comparing the identified punctuation marks with a punctuation configuration setting for message types, and determining if the message is an urgent message or non-urgent message based on the punctuation marks.

6. The method of claim 4 wherein the analyzing the grammatical structure comprises identifying one or more alphanumerics in the message, comparing the identified alphanumerics with an alphanumeric configuration setting for message types, and determining if the message is an urgent message or non-urgent message based on the comparison.

7. The method of claim 4 wherein an urgent message is determined by at least one of a number of words in the message, at least one punctuation mark in the message and at least one alphanumeric in the message.

8. The method of claim 1 wherein analyzing the message further comprises:
determining if a sent message flag stored in the device corresponds to the received message; and
if the sent message flag corresponds to the received message, marking the received message as an urgent message.

9. The method of claim 8 further comprising:
detecting a message being sent by the user;
analyzing the message to determine at least a recipient of the sent message and if the message is a question; and
setting the sent message flag in the device.

10. The method of claim 1 further wherein analyzing the received message further comprises:
determining if the received message is a first message received from a sender of the message; and
if the received message is not the first message, comparing a number of messages received from the sender over a pre-determined time period with a received messages configuration setting criteria and marking the received message as an urgent message if the criteria is satisfied.

11. The method of claim 10 further comprising re-marking all previously received non-urgent messages from the sender as urgent messages when the criteria is satisfied and providing new notifications to the user.

12. The method of claim 1 wherein the analysis further comprises determining a status setting of the device, wherein if the status setting is busy, all messages are marked as non-urgent and a low intensity notification is provided to the user.

13. The method of claim 1 wherein the message is an instant message or a text message.

14. The method of claim 1 wherein the notification for an urgent type message varies in intensity from a non-urgent type message.

15. An apparatus comprising:
a message analysis engine configured to determine a type of content of a message received by the apparatus; and
a message notification engine configured to provide a notification to user that is dependent upon the type of content.

16. The apparatus of claim 15 wherein the analysis engine is configured to determine the type of content of the message based on a grammatical structure of the message.

17. The apparatus of claim 15 wherein the type of content is urgent or non-urgent and a notification for an urgent message is of a greater intensity that a notification for a non-urgent message.

18. The apparatus of claim 15 wherein the notification engine varies an intensity of the notification depending on the type of content.

19. The apparatus of claim 15 wherein the apparatus is a mobile communications terminal.

20. The apparatus of claim 15 wherein the message analysis engine is further configured to analyze a content of an outgoing message, determine if the outgoing message is a type requiring a response, set a response waiting flag in the apparatus when the message is of a type requiring a response, and wherein the notification engine automatically provides an urgent type notification to the user when the received message is determined to be a response message.

21. The apparatus of claim 15 wherein the notification engine is configured to provide a looping notification that varies over time, wherein a notification for an urgent type message varies at a faster rate than a notification for a non-urgent message.

22. The apparatus of claim 15 wherein the notification engine is configured to provide a two-part notification comprising a first part to indicate a presence of the message and a second part to indicate the type of message.

23. The apparatus of claim 22 wherein the notification engine maintains the first part of the notification constant and varies an intensity of the second part depending on the type of message.

24. The apparatus of claim 15 wherein the message analysis engine is configured to determine a sender of the message, compare the sender to a pre-determined list, and if a match, categorize the message as an urgent message wherein the notification engine provides a high intensity message notification.

25. A computer program product stored in a memory comprising:
computer readable program code embodied in a computer readable medium for executing the method of claim 1.

26. A user interface comprising:
an icon notifying a user of a message received in a device, the icon comprising a first part and a second part; wherein
the first part identifies that the message has been received by the device; and
the second part identifies a type of a content of the message.

27. The user interface of claim 26 wherein the second part varies in intensity with respect to the first part, and an urgent type message has a higher intensity that a non-urgent type message.

28. The user interface of claim 26 wherein the type of content of the message is categorized as urgent or non-urgent, and a message notification is dependent on the categorization, wherein a notification for a non-urgent message is less intense than a message for an urgent message.

29. An apparatus comprising:
means for determining a type of content of a message received by the apparatus; and
means for providing a notification to user that is dependent upon the type of content.

30. The apparatus of claim 29 further comprising means for determining the type of content of the message based on a grammatical structure of the message.

31. The apparatus of claim 29 further comprising means for varying an intensity of the notification depending on the type of content.
